(19) United States
(12) Patent Application Publication
(10) Pub. No.: US 2007/0052682 A1
(43) Pub. Date: Mar. 8, 2007

(54) Method of inputting a character using a software keyboard

(76) Inventors: Yun-Kee Kang, Seoul (KR); Hoon-Kee Kang, Seoul (KR)

Correspondence Address: HARNESS, DICKEY & PIERCE, P.L.C., P.O. BOX 828, BLOOMFIELD HILLS, MI, 48303, US

(21) Appl. No.: 10/522,123

(22) PCT Filed: Aug. 8, 2003
(86) PCT No.: PCT/KR03/01595

§ 371 Date: Aug. 30, 2005

(30) Foreign Application Priority Data
Aug. 16, 2002 (KR) 10 2002 0048343
Dec. 26, 2002 (KR) 10 20020083836

(51) Int. Cl. G09G 5/00; G06F 15/02

(52) U.S. Cl. 345/173; 341/22

(57) ABSTRACT

The present invention relates to a method of inputting a character using a software keyboard, and more particularly relates to a method of inputting a character using software keyboard used for inputting a character of mobile terminal (such as, PDA) using touch screen. The method for inputting a character using a software keyboard comprising a certain number of blocks, each of capital characters being assigned to the respective blocks, and peripheral character block being located at peripheral regions of each of the blocks and being activated when a corresponding capital character block is touched according to the invention comprise the step of inputting the capital character by touching a capital character block to which a character to input is assigned; and, inputting the character of peripheral character block by touching a capital character block to which a character to input belongs and by dragging to a corresponding peripheral character block. Hence, it is not necessary to arrange all of keys on keyboard as prior art such that mistake is prevented and further the eye becomes not fatigued.

### BACKGROUND OF THE INVENTION

1. Field of the Invention

The present invention relates to a method of inputting a character using a software keyboard, and more particularly relates to a method of inputting a character using software keyboard used for inputting a character of mobile terminal (such as, PDA) using touch screen.

2. Description of the Related Art

In recently, mobile terminal using touch screen is broadly popularized with development of electronic technology.

In order to input a certain character using such a mobile terminal, a corresponding key have to be touched by hands or touch pen in software keyboard having same arrangement of real keyboard, which is displayed on touch screen.

But, since the software keyboard being displayed on mobile terminal using a usual touch screen is displayed equally to real keyboard in limited screen area, size of key is very small such that eye becomes fatigued and missing is occurred very easily. Further, a device having a small area of touch screen (particularly, such as watch phone) is more serious.

To solve these problems, as shown in FIG. 7, a method is disclosed in which only a capital-characters of Japanese (that is, [symbol] (a), [symbol] (ka), [symbol] (sa), [symbol] (ta), [symbol] (na), [symbol] (ha), [symbol] (ma), [symbol] (ya), [symbol] (ra), [symbol] (wa)) are assigned to each block, if one of the capital characters (here, [symbol] (ma)) is touched characters belonging to the touched capital character [symbol] (ma), [symbol] (mi), [symbol] (mu), [symbol] (me), [symbol] (mo)) is displayed in the form of a fan, and a certain character is inputted by drawing to the desired character [Japanese patent open-laid number 2000-287630]

But, in this method, it can be known that which character is assigned to particular block only via 1) first step in which only a capital-characters are displayed, 2) second step in which if one of the capital-characters is selected, characters belonging to the selected capital character are displayed in the form of fan, and 3) third step in which user draw to the desired character. Further, an initially displayed capital-character blocks are functions only as a switch for displaying characters belonging to the initially displayed capital characters.

Hence, time for inputting a character is longer since 3 steps are needed to input a certain character, and missing is occur very easily since area of each character is very small in pan shape shown in the second step.

### SUMMARY OF THE INVENTION

To solve these problems, the present invention provide a method of inputting a character using software keyboard in that by arranging peripheral-characters associated with a capital-characters at up, down, left, and right area of each capital-character blocks, location of character is known without touching a capital character to which a peripheral character belongs such that time for inputting a character is shortened, and area of peripheral-character blocks to which peripheral character is assigned is larger than that of a conventional pan shape such that mistake is reduced.

### BRIEF DESCRIPTION OF THE DRAWINGS

FIG. 1 is an exterior view of mobile terminal using touch screen according to the present invention.

FIG. 2 is shown a principle of operation of a software keyboard.

FIG. 3a is arrangement of English software keyboard according to the first embodiment of the invention, and FIG. 3b is shown a state that English keyboard shown in FIG. 3a is implemented on cell.

FIG. 4a, 4b, 4c, and 4d are shown a variety of symbol displayed on peripheral-character blocks.

FIG. 5a is arrangement of Japanese software keyboard according to the second embodiment of the present invention, and FIG. 5b is shown a state that Japanese keyboard shown in FIG. 5a is implemented on cell.

FIGS. 6a and 6b are shown a variety of symbol displayed on peripheral character blocks.

FIG. 7 is shown the prior software keyboard.

### DETAILED DESCRIPTION OF THE INVENTION

To achieve the above objects, a method for inputting a character using a software keyboard comprising a certain number of blocks, each of capital characters being assigned to the respective blocks, and peripheral character block being located at peripheral regions of each of the blocks and being activated when a corresponding capital character block is touched according to the invention comprise the step of: inputting the capital character by touching a capital character block to which a character to input is assigned; and, inputting the character of peripheral character block by touching a capital character block to which a character to input belongs and by dragging to a corresponding peripheral character block.

The capital character block and the peripheral character block are overlapped.

Area of the touched capital character block in the capital character blocks is larger than that of the non-touched capital character blocks.

Bars are displayed on the peripheral character blocks when a capital character block to which the peripheral character blocks belong is touched.

A corresponding character is directly displayed on the peripheral character block when a capital character block to which the peripheral character blocks belong is touched.

The peripheral character blocks are located at up, down, left, and right of the capital character block.

When English (‘A, D, G, J, M, P, S, V, and Y’) are assigned to the capital character blocks, ‘A,B,C’, ‘D,E,F’, ‘G,H,I’, ‘J,K,L’, ‘M,N,O’, ‘P,Q,R’, ‘S,T,U’, ‘V,W,X’, ‘Y,Z’ are assigned to a peripheral character blocks located at up, down, left, and right of the capital character blocks respectively.

A big/small letter changing block for changing a big letter into a small letter is assigned to a peripheral character block located at left of the capital character block.

‘(A,a), (B,b), (C,c)’, ‘(D,d), (E,e), (F,f)’, ‘(G,g), (H,h), (I,i)’, ‘(J,j), (K,k), (L,l)’, ‘(M,m), (N,n), (O,o)’, ‘(P,p), (Q,q), (R,r)’, ‘(S,s), (T,t), (U,u)’, ‘(V,v), (W,w), (X,x)’, ‘(Y,y), (Z,z)’ are assigned to peripheral character blocks located at up, down, left, and right of the capital character blocks respectively.

When [symbol] (a), [symbol] (ka), [symbol] (sa), [symbol] (ta), [symbol] (na), [symbol] (ha), [symbol] (ma), [symbol] (ya), [symbol] (ra), [symbol] (wa) are assigned to the capital character blocks respectively, [symbol] (i), [symbol] (u), [symbol] (e), [symbol] (o)′, [symbol] (ki), [symbol] (ku), [symbol] (ke), [symbol] (ko)′, [symbol] (shi), [symbol] (su), [symbol] (se), [symbol] (so)′, [symbol] (chi), [symbol] (tau), [symbol] (te), [symbol] (to)′, [symbol] (ni), [symbol] (nu), [symbol] (ne), [symbol] (no)′, [symbol] (hi), [symbol] (fu), [symbol] (he), [symbol] (ho)′, [symbol] (mi), ≠(mu), [symbol] (me), [symbol] (mo)′, [symbol] (yu), [symbol] (yo)′, [symbol] (ri), [symbol] (ru), [symbol] (re), [symbol] (ro)′, ′ [symbol] (n), [symbol] (o)′ are assigned to peripheral character blocks of the capital character blocks respectively.

Blocks are further assigned which generates Katakana of the capital character and peripheral character.

A Chinese character changing block for changing a character into Chinese character, a sokuon changing block for changing into sokuon, a dakuon changing block for changing into dakuon, a handakuon changing block for changing into handakuon, and a tiyouon changing block for changing into tiyouon are arranged respectively or arranged as a peripheral blocks of one block.

Special symbols may assigned to the capital character blocks and peripheral character blocks.

Now, a preferred embodiment of the invention will be described with reference to the accompanying drawings.

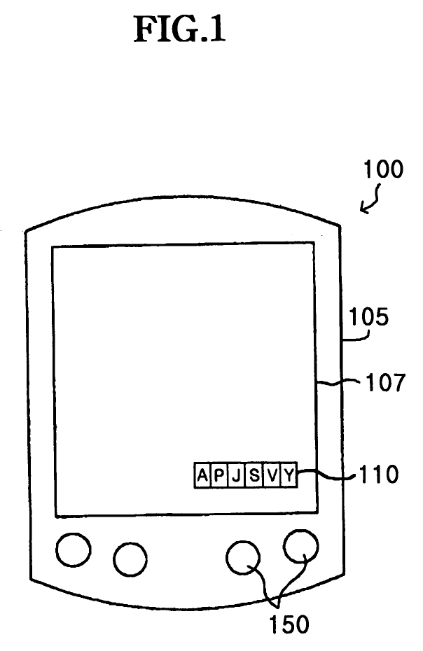

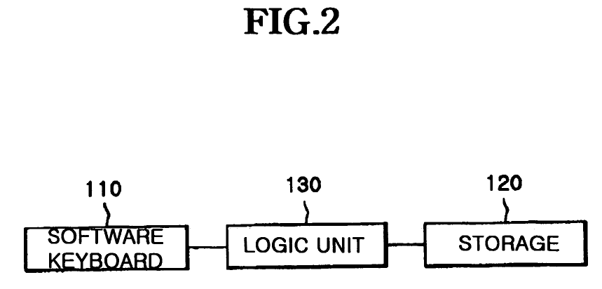

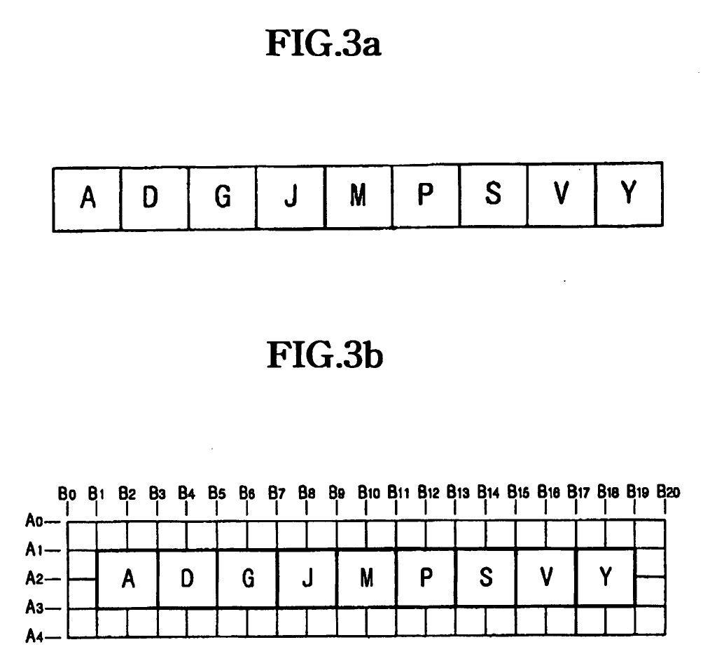

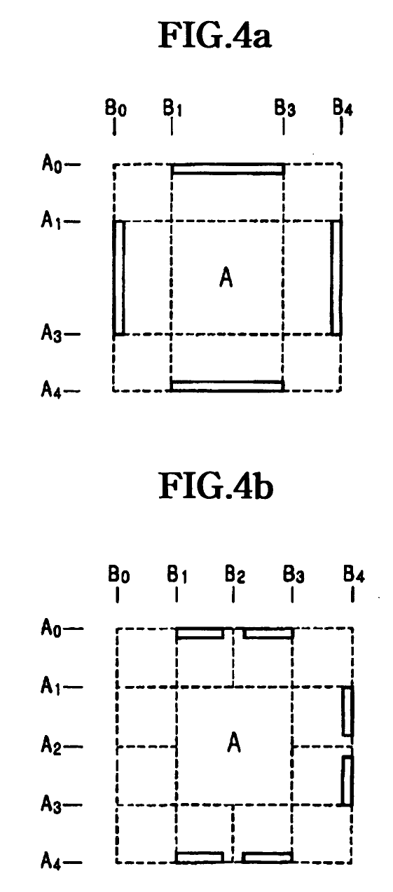

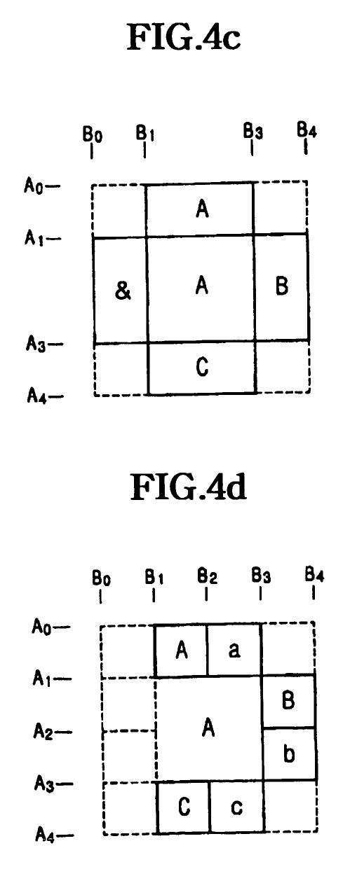

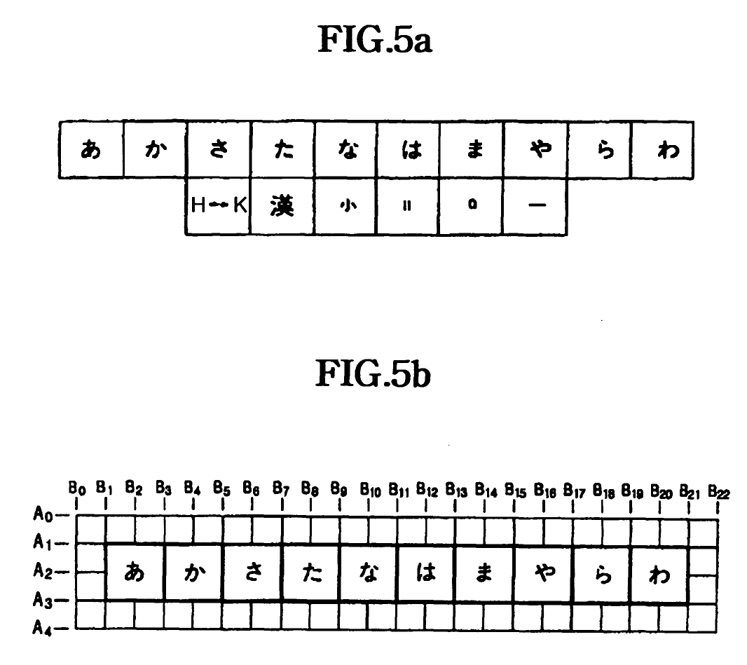

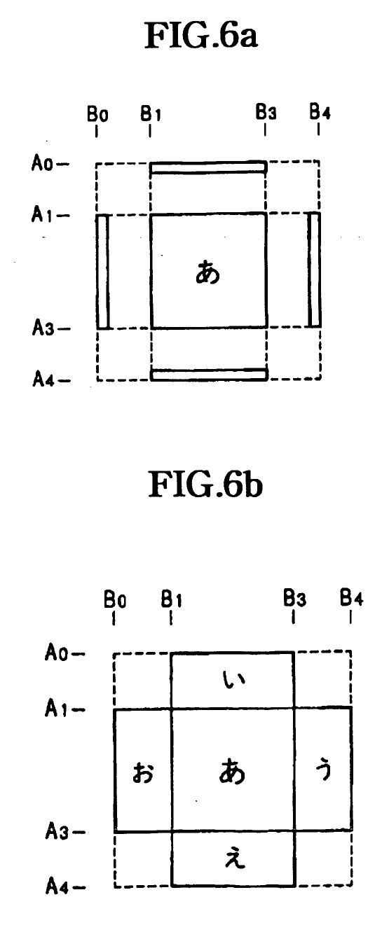

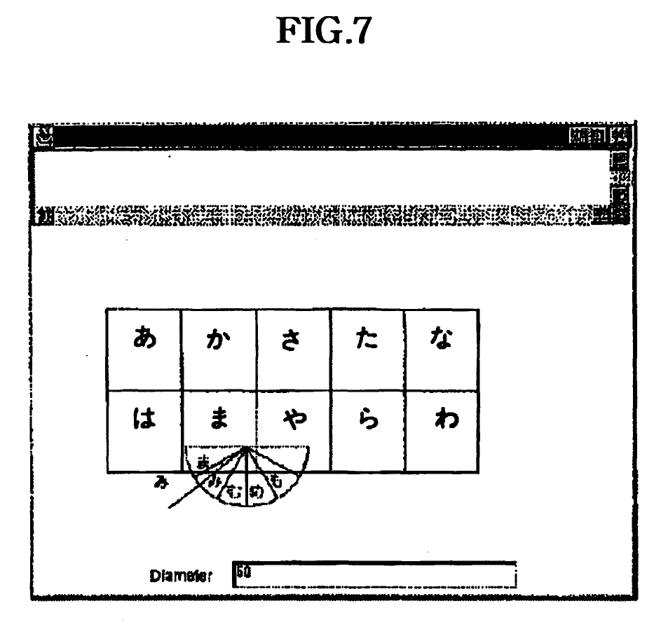

FIG. 1 is an exterior view of mobile terminal using touch screen according to the present invention. FIG. 2 is shown a principle of operation of a software keyboard. And, FIG. 3a is arrangement of English software keyboard according to the first embodiment of the invention, and FIG. 3b is shown a state that English keyboard shown in FIG. 3a is implemented on cell. FIG. 4a, 4b, 4c, and 4d are shown a variety of symbol displayed on peripheral character blocks. FIG. 5a is arrangement of Japanese software keyboard according to the second embodiment of the present invention, and FIG. 5b is shown a state that Japanese keyboard shown in FIG. 5a is implemented on cell. And, FIGS. 6a and 6b are shown a variety of symbol displayed on peripheral character blocks. FIG. 7 is shown the prior software keyboard.

As shown in FIG. 1, a mobile terminal 100 using touch screen according to the invention comprises a body 105, a display portion 107 located at front face of the body 105, and control key 150 for controlling a general operation.

And, a software keyboard 110 used for inputting character may be displayed on the display portion 107.

An operation principle of the software keyboard 110 is as below.

As shown in FIG. 2, character inputting signals generated by touching with hands or a touch pen is send from software keyboard 110 to a central logic unit 130, and the central logic unit 130 control a storage means 120 to read a related character from the storage means, generate a character displaying signals, and send the character displaying signals to the software keyboard 110 to input a desired character.

Preferably, the software keyboard 110 is comprised of a several blocks as will be described below, a capital characters are assigned to the blocks, and a peripheral characters belonging to the capital character are assigned to a peripheral blocks located at up, down, left, and right of the capital-character block.

As used to herein, the term ‘capital-character’ may be ‘A, D, G, J, M, P, S, V, Y’, for example when a character for display is an English, and the term ‘peripheral-character’ is a character belonging to the capital-character, that is when capital character is ‘A’, ‘A,B,C’ is a peripheral character. As described above, ‘capital-character’ means a character used for reducing a particular character to a certain number of character, and ‘peripheral-character’ means characters belonging to ‘the capital-character’. And, the term ‘peripheral’ is a location located at up, down, left, and right of the capital-character block which capital characters are assigned respectively, and thus ‘peripheral-blocks’ means blocks located in up, down, left, and right of ‘the capital-character block’.

Next, a method will be described for inputting an English and Japanese using the software keyboard. Of course, the English and Japanese are for illustrated only for example, hence the present invention is not limited thereto.

### The First Embodiment

First, a method for inputting an English will be described.

As shown in FIG. 3a, a English software keyboard according to the present invention is comprised of a capital characters (‘A,D,G,J,M,P,S,V,Y’), not comprised of all characters as a prior art.

‘A,B,C’ is assigned to a key A, ‘D,E,F’ is assigned to a key D, ‘G,H,I’ is assigned to a key G, ‘J,K,L’ is assigned to a key J, ‘M,N,O’ is assigned to a key M, ‘P,Q,R’ is assigned to a key P, ‘S,T,U’ is assigned to a key S, ‘V,W,X’ is assigned to a key V, and ‘Y,Z’ is assigned to a key ‘Y’ respectively. If a certain key (that is, capital character block) is touched a corresponding capital character is inputted, and if it is dragged to one of the up, down, left, and right direction in state of key is touched a corresponding peripheral character is inputted.

For help to understand, FIG. 3 is shown in that such an English software keyboard is implemented on cell.

As illustrated in FIG. 3, if one of capital character blocks is touched, the touched capital character block is activated together with a peripheral blocks thereof such that a size of the touched capital character block becomes larger than that of non-touched capital character blocks, and thus the capital character or peripheral characters related thereto can be inputted by dragging to a desired direction. That is, if a capital character block A is touched, cell area (A0,A4-B0,B4) is activated and the size thereof become lager, if a capital character block D is touched, cell area (A0,A4-B2,B6) is activated and the size thereof become lager, if a capital character block G is touched, cell area (A0,A4-B4,B8) is activated and the size thereof become lager, if a capital character block J is touched, cell area (A0,A4-B6,B10) is activated and the size thereof become lager, if a capital character block M is touched, cell area (A0,A4-B8,B12) is activated and the size thereof become lager, if a capital character block P is touched, cell area (A0,A4-B10,B14) is activated and the size thereof become lager, if a capital character block S is touched, cell area (A0,A4-B12,B16) is activated and the size thereof become lager, if a capital character block V is touched, cell area (A0,A4-B14,B18) is activated and the size thereof become lager, if a capital character block Y is touched, cell area (A0,A4-B16,B20) is activated and the size thereof become lager, and thus a capital character or peripheral character can be inputted.

Here, cell area (A0,A4-B3,B4) (more precisely, block (A1,A3-B3,B4)) functions as a capital character block of capital character D, and also functions as a peripheral character block of capital character A. block (A1,A3-B2,B3) is of course functions as a capital character block of capital character A, and also functions as a peripheral character block of capital character block D. that is, a capital character block and a peripheral character block may be overlapped.

In such an English software keyboard, it will be described a variety of symbol which is displayed when a peripheral character block is activated by touching a capital character block.

As shown in FIG. 4a, for example, if a capital character block ‘A’ is touched, a peripheral character blocks (A1,A3-B0,B1), (A0,A1-B1,B3), (A1,A3-B3,B4), (A3,A4-B1, B3) are activated and size thereof becomes larger, thereby a bar(▭) are displayed which means A, B, C, and a big/small letter changing respectively (a bar locating at upper position means an A, a bar locating at right position means a B, a bar locating at down position means a C, and a bar locating at left position means a big/small letter changing).

Here, a character A,B,C and a big/small letter changing are inputted by dragging to the desired directions. For instance, a process for inputting a character ‘B’ is as below: first, if a capital character block A to which peripheral character ‘B’ belongs is touched, a peripheral character blocks (A1,A3-B0,B1), (A0,A1-B1,B3), (A1,A3-B3,B4), (A3,A4-B1,B3) are activated such that bar are displayed. If the bars are displayed, English ‘B’ can be inputted by dragging to a peripheral-character block (A1,A3-B3,B4) in state a capital-character block A is touched. Here, a peripheral-character block B (A1,A3-B3,B4) functions as a peripheral-character block B in state the capital-character block A is touched, but functions as a capital-character block D if it is touched in itself as described above.

And, in FIG. 4b, a small letter may be assigned to side of each of capital-character block without using a big/small letter changing block (A1,A3-B0,B1) as shown in FIG. 4a. a bar meaning a big letter ‘A’ is displayed on peripheral character block (A0,A1-B1,B2), a bar meaning a small letter ‘a’ is displayed on peripheral character block (A0,A1-B2,B3), a bar meaning a big letter ‘B’ is displayed on peripheral character block (A1,A2-B3,B4), a bar meaning a small letter ‘b’ is displayed on peripheral character block (A2,A3-B3,B4), a bar meaning a big letter ‘C’ is displayed on peripheral character block (A3,A4-B1,B2), and a bar meaning a small letter ‘c’ is displayed on peripheral character block (A3,A4-B2,B3), and thus a corresponding character may be inputted by dragging to the desired block.

Here, while bars displayed on each block are shown same size in FIGS. 4a and 4b, the ordinary skilled in the art will be understood that a different size and/or color of bar may be displayed on every block. For example, a thicker bar can be displayed on a big letter and a thinner bar can be displayed on a small letter, or bars may be colored differently.

Next, FIGS. 4c and 4d will be described.

A principle of FIGS. 4c and 4d are similar to that of FIGS. 4a and 4b, and an assigned characters instead of bar are displayed on each block directly. That is, as shown in FIG. 4c, character ‘A’ instead of bar is displayed directly on peripheral character block (A0,A1-B1,B3), character ‘B’ is displayed directly on peripheral character block (A1,A3-B3,B4), character ‘C’ is displayed directly on peripheral character block (A3,A4-B1,B3), and a big/small letter changing ‘&’ is displayed directly on peripheral character block (A1,A3-B0,B1). That is, a certain character can be inputted by dragging to the desired direction while seeing character of a corresponding block, and thus anyone knows very easily graphically.

And, as shown in FIG. 4d, a big letter ‘A’ is displayed directly on peripheral-character block (A0,A1-B1,B2), a small letter ‘a’ is displayed directly on peripheral-character block (A0,A1-B2,B3), a big letter ‘B’ is displayed directly on peripheral-character block (A1,A2-B3,B4), a small letter ‘b’ is displayed directly on peripheral-character block (A2,A3-B3,B4), a big letter ‘C’ is displayed directly on peripheral-character block (A3,A4-B1,B2), a small letter ‘c’ is displayed directly on peripheral-character block (A3,A4-B2,B3) and thus a big/small letter can be inputted by dragging to the desired block.

As described above, in the keyboard to which only capital character is assigned, if key of a certain capital character is touched a peripheral blocks arranged to up, down, right, and left of the touched capital character are activated and size thereof becomes larger, thereby it is easily conceived, and peripheral characters assigned to peripheral blocks can be easily inputted by dragging to the desired direction.

### The Second Embodiment

Now, a method for inputting a Japanese will be described. The principle of the method is similar to that of the above English inputting method.

As shown in FIG. 5a, Japanese software keyboard according to the present invention is comprised of capital character as above English software keyboard.

′ [symbol] (i), [symbol] (u), [symbol] (e), [symbol] (o)′ is assigned to a key [symbol] (a), [symbol] (ki), [symbol] (ku), [symbol] (ke), [symbol] (ko)′ is assigned to a key [symbol] (ka), [symbol] (shi), [symbol] (su), [symbol] (se), [symbol] (so)′ is assigned to a key [symbol] (sa), [symbol] (chi), [symbol] (tau), [symbol] (te), [symbol] (to)′ is assigned to a key [symbol] (ta), ′ [symbol] (ni), [symbol] (nu), [symbol] (ne), [symbol] (no)′ is assigned to a key [symbol] (na), [symbol] (hi), [symbol] (fu), [symbol] (he), [symbol] (ho)′ is assigned to a key [symbol] (ha), [symbol] (mi), [symbol] (mu), [symbol] (me), [symbol] (mo)′ is assigned to a key [symbol] (ma), [symbol] (yu), [symbol] (yo)′ is assigned to a key [symbol] (ya), [symbol] (ri), [symbol] (ru), [symbol] (re), [symbol] (ro)′ is assigned to a key [symbol] (ra), and [symbol] (n), [symbol] (o)′ is assigned to a key [symbol] (wa) respectively. Also, Hiragana/Katakana changing key (H [symbol] K) for changing between Hiragana and Katakana, a Chinese character changing key ( [symbol] ) for changing a certain character to Chinese character, a sokuon changing key( [symbol] ) for changing Japanese to sokuon, a dakuon changing key(”) for changing into dakuon, a handakuon changing key(°) for changing into handakuon, and a tiyouon changing key [symbol] for changing into tiyouon are assigned. Here, all of the Hiragana/Katakana changing key, the Chinese character changing key, a sokuon changing key, a dakuon changing key, a handakuon changing key, and a tiyouon changing key may be assigned to single block (that is, Hiragana/Katakana changing function may be assigned to upper position of the one block, a Chinese character changing function may be assigned to down position thereof, a sokuon changing function may be assigned to right position, a handakuon changing function may be assigned to left position, and a tiyouon changing function may be assigned to middle position respectively).

For help to understand, FIG. 5b is shown in that such a Japanese software keyboard is implemented on cell. Similar to the above English, if a capital-character block [symbol] (a) is touched a cell area(A0,A4-B0,B4) is activated such that a size thereof becomes larger, if a capital-character block [symbol] (ka) is touched a cell area(A0,A4-B2,B6) is activated such that a size thereof becomes larger, if a capital-character block [symbol] (sa) is touched a cell area(A0,A4-B4,B8) is activated such that a size thereof becomes larger, if a capital-character block [symbol] (ta) is touched a cell area (A0,A4-B6,B10) is activated such that a size thereof becomes larger, if a capital-character block [symbol] (na) is touched a cell area(A0,A4-B8,B12) is activated such that a size thereof becomes larger, if a capital-character block [symbol] (ha) is touched a cell area(A0,A4-B10,B14) is activated such that a size thereof becomes larger, if a capital-character block [symbol] (ma) is touched a cell area(A0,A4-B12,B16) is activated such that a size thereof becomes larger, if a capital-character block [symbol] (ya) is touched a cell area(A0,A4-B14,B18) is activated such that a size thereof becomes larger, if a capital-character block [symbol] (ra) is touched a cell area(A0,A4-B16,B20) is activated such that a size thereof becomes larger, if a capital-character block [symbol] (wa) is touched a cell area(A0,A4-B18,B22) is activated such that a size thereof becomes larger, and thus a certain character can be inputted by dragging to the desired block.

In such a Japanese software keyboard, a variety of symbol will be described which displayed by touching a capital-character block.

As shown in FIG. 6a, for example, bars meaning [symbol] (i), [symbol] (u), [symbol] (e), [symbol] (o) are displayed on a peripheral-character blocks (A0,A1-B1,B3)(A1,A3-B3,B4)(A3,A4-B1,B3)(A1,A3-B0,B1) of a capital-character block [symbol] (a) respectively. Here, [symbol] (a) is inputted by touching a capital-character block [symbol] (a), and a peripheral-character ( [symbol] (i), [symbol] (u), [symbol] (e), [symbol] (o)) assigned to peripheral blocks are inputted by dragging to the desired block in state the capital-character block [symbol] (a) is touched.

Next, FIG. 6b will be described. A corresponding character instead of bar in FIG. 6a is directly displayed in FIG. 6b.

As shown in FIG. 6b, a character [symbol] is directly displayed on a capital character block (A1,A3-B1,B3), a character [symbol] is directly displayed on a peripheral character block (A0,A1-B1,B3), a character [symbol] is directly displayed on a peripheral character block (A1,A3-B3,B4), a character [symbol] is directly displayed on a peripheral character block (A3,A4-B1,B3), and a character [symbol] is directly displayed on a peripheral character block (A1,A3-B0,B1). Hence, a capital character can be inputted by touching a capital character block, and a peripheral-character is inputted by dragging from the capital character to the character (that is, character located at up, down, left, and right of a capital-character).

As discussed above, a capital-character block functions as a capital-character block for inputting a particular capital-character, and also functions as a switch for activating a peripheral-character block to which the capital character belongs, that is, the capital-character block carry out two functions. This is differs from the prior art that a capital-character block functions only as a switch.

Further, in inputting a peripheral-character, while it is impossible to know which character is assigned to particular block until a pan is displayed in prior art, a peripheral-character is located at up, down, left, and right of a capital-character blocks in the present invention thus it is easy to know a peripheral-character assigned to each capital-character need not to touch a capital character block. That is, the present invention is a method for inputting a character using up, down, left, and right direction of a capital-character.

Until now, while the method for inputting character using the English and Japanese software keyboard are described, a people pertain to those skilled in the art should be understood that method for inputting a character using a software keyboard to which special symbols (for example, +,−,*,/, (,), [,], <.> and so on) other than the above English and Japanese are arranged is also available.

### INDUSTRIAL APPLICABILITY

As described above, A method for inputting a character using a software keyboard comprising a certain number of blocks, each of capital characters being assigned to the respective blocks, and peripheral character block being located at peripheral regions of each of the blocks and being activated when a corresponding capital character block is touched according to the invention comprise the step of: inputting the capital character by touching a capital character block to which a character to input is assigned; and, inputting the character of peripheral character block by touching a capital character block to which a character to input belongs and by dragging to a corresponding peripheral character block. Thereby, it is not necessary to arrange all of the keys on keyboard as prior art and a mistake is prevented and further the eye becomes not fatigued.

Also, because of arranging a peripheral-character belonging to the capital-character at peripheral blocks located up, down, left, and right area of the capital-character blocks, mistake is reduced by dragging to the corresponding peripheral-character, and it is easily known to which character is assigned to the peripheral-character blocks.

Particularly, since a peripheral characters belonging to capital character are assigned to the block located up, down, left, and right of the capital-character block unlikely to prior art when a Japanese is inputted, it is known to which character is assigned to block without activating a peripheral-character block and thus time for input a character may be reduced.

While the present invention has been described as a example of English and Japanese, people those skilled in the art should be understood that the present invention could be applied to another language. And, the present invention is applicable to devices such as smart phone, electronic note, mobile terminals, electronic dictionary, interactive TV.

What is claimed is:

1. A method for inputting a character using a software keyboard comprising a certain number of blocks, each of capital characters being assigned to the respective blocks, and peripheral character block being located at peripheral regions of each of the blocks and being activated when a corresponding capital character block is touched, the method comprising the step of: inputting the capital character by touching a capital character block to which a character to input is assigned; and, inputting the character of peripheral character block by touching a capital character block to which a character to input belongs and by dragging to a corresponding peripheral character block.

2. the method according to claim 1, wherein the capital character block and the peripheral character block are overlapped.

3. the method according to claim 1, wherein area of the touched capital character block is larger than that of the non-touched capital character blocks.

4. The method according to any one of claims 1 to 3, wherein bars are displayed on the peripheral character blocks when a capital character block to which the peripheral character blocks belongs is touched.

5. The method according to any one of claims 1 to 3, wherein a corresponding character is directly displayed on the peripheral character block when a capital character block to which the peripheral character blocks belongs is touched.

6. The method according to any one of claims 1 to 3, wherein the peripheral character blocks are located at up, down, left, and right area of the capital character block.

7. the method according to claim 1, wherein when English (‘A, D, G, J, M, P, S, V, and Y’) are assigned to the capital character blocks respectively, ‘A,B,C’, ‘D,E,F’, ‘G,H,I’, ‘J,K,L’, ‘M,N,O’, ‘P,Q,R’, ‘S,T,U’, ‘V,W,X’, and ‘Y,Z’ are assigned to a peripheral character blocks located at up, down, left, and right of the capital character blocks respectively.

8. the method according to claim 7, wherein a big/small letter changing block for changing a big letter into a small letter is assigned to a peripheral character block located at left of the capital character block.

9. the method according to claim 1, wherein ‘(A,a), (B,b), (C,c)’, ‘(D,d), (E,e), (F,f)’, ‘(G,g), (H,h), (I,i)’, ‘(J,j), (K,k), (L,l)’, ‘(M,m), (N,n), (O,o)’, ‘(P,p), (Q,q), (R,r)’, ‘(S,s), (T,t), (U,u)’, ‘(V,v), (W,w), (X,x)’, ‘(Y,y), (Z, z)’ are assigned to peripheral character blocks located at up, down, left, and right of the capital character blocks respectively.

10. the method according to claim 1, wherein when [symbol] (a), [symbol] (ka), [symbol] (sa), [symbol] (ta), [symbol] (na), [symbol] (ha), [symbol] (ma), [symbol] (ya), [symbol] (ra), [symbol] (wa) are assigned to the capital character blocks respectively, [symbol] (i), [symbol] (u), [symbol] (e), [symbol] (o)′, [symbol] (ki), [symbol] (ku), [symbol] (ke), [symbol] (ko)′, [symbol] (shi), [symbol] (su), [symbol] (se), [symbol] (so)′, [symbol] (chi), [symbol] (tau), [symbol] (te), [symbol] (to)′, [symbol] (ni), [symbol] (nu), [symbol] (ne), [symbol] (no)′, [symbol] (hi), [symbol] (fu), [symbol] (he), [symbol] (ho)′, [symbol] (mi), [symbol] (mu), [symbol] (me), [symbol] (mo)′, [symbol] (yu), [symbol] (yo)′, [symbol] (ri), [symbol] (ru), [symbol] (re), [symbol] (ro)′, [symbol] (n), [symbol] (o)′ are assigned to peripheral character blocks of the capital character blocks respectively.

11. the method according to claim 10, wherein a block is further assigned which generates Katakana of the capital character and peripheral character.

12. the method according to claims 10 or 11, wherein a Chinese character changing block for changing a character into Chinese character, a sokuon changing block for changing into sokuon, a dakuon changing block for changing into dakuon, a handakuon changing block for changing into handakuon, and a tiyouon changing block for changing into tiyouon are arranged respectively or arranged as a peripheral blocks of one block.

13. the method according to any on of claims 1 to 3, wherein a special symbols is assigned to the capital character blocks and peripheral character blocks.
